(19) United States
(12) Patent Application Publication
(10) Pub. No.: US 2012/0200048 A1
(43) Pub. Date: Aug. 9, 2012

(54) TOOL CLAMPING SYSTEM AND MACHINE TOOL HAVING A TOOL CLAMPING SYSTEM

(76) Inventors: Juergen Hilzinger, Renningen (DE); Andre Meyer, Remseck (DE); Jochen Roser, Leonberg-Gebersheim (DE); Heiner Storck, Korntal-Muenchingen (DE)

(21) Appl. No.: 13/368,113

(22) Filed: Feb. 7, 2012

(30) Foreign Application Priority Data
Feb. 8, 2011 (DE) 102011003785.3

(51) Int. Cl. B23B 31/02

(52) U.S. Cl. 279/16

(57) ABSTRACT

A tool clamping system for clamping an insert tool in a machine tool having a housing, in particular an ultrasound-operated machine tool, the insert tool being capable of being placed into a tool mount of the machine tool and clamped there. The tool mount has a clamping element having an operating area that works together with a housing operating area of the housing at least for the clamping of the insert tool, and that, in the operating state of the insert tool, is separated from the housing operating area by a gap.

### CROSS REFERENCE

The present application claims the benefit under 35 U.S.C. §119 of German Patent Application No. DE 102011003785.3 filed on Feb. 8, 2011, which is expressly incorporated herein by reference in its entirety.

### FIELD OF THE INVENTION

The present invention relates to a tool clamping system and to a machine tool having a tool clamping system.

### BACKGROUND INFORMATION

In machine tools having exchangeable insert tools, these tools must be clamped in place. There are a number of variant ways of achieving this. In the case of insert tools to which a high frequency, e.g., ultrasound, is wholly or partly applied for a working movement, very large holding forces must be applied in order to make it possible to transfer the high accelerations at the insert tool caused by the ultrasound with as little loss as possible.

### SUMMARY

According to a first aspect of the present invention, a tool clamping system is proposed for clamping an insert tool in a machine tool having a housing, in particular an ultrasound-operated machine tool, the insert tool being capable of being placed into a tool mount of the machine tool and clamped there. The tool mount has a clamping element that has an operating area that works together with an operating area of the housing at least for the clamping of the insert tool, and that, in the operating state of the insert tool, is separated from the housing operating area by a gap.

The present invention may have on the one hand the advantage that the insert tool can be at least clamped to a region of the housing, and also released if warranted. Therefore, a separate clamping tool, such as an open-end wrench or the like, can be done without. Clamping and possible release of the insert tool can be accomplished without using tools, directly at the machine tool. Large clamping forces can be achieved. The machine tool can be an electric machine tool or a hydraulically or mechanically driven machine tool. Particularly advantageously, the machine tool can be an ultrasound-operated machine tool in which the insert tool executes a working movement with a high frequency, in particular ultrasound. Because the operating area of the clamping element and the housing operating area are separated by a gap in the operating state of the insert tool, the high-frequency working movement is not damped by friction between the housing operating area and the operating area of the clamping element. The housing operating area can advantageously have at least one stop with which a stop element of the operating area comes into contact when the insert tool is clamped or is to be released if necessary.

According to an advantageous embodiment, the housing operating area can be fashioned so as to have a shape complementary to that of the operating area of the clamping element. Usefully, the housing operating area can surround the operating area at least in some regions. “Complementary in shape” is intended to mean that the housing operating area has at least one stop with which a corresponding stop element of the operating area can come into contact. In particular, the operating area can be fashioned as a polygon, and the housing operating area can be fashioned as an inner polygon, such that the outer side of the operating area fashioned as a polygon comes into contact with the inner side of the housing operating area when the housing operating area is rotated relative to the operating area, and, in the state in which contact takes place, can transmit a torque.

According to an advantageous embodiment, the clamping element can be fashioned as a polygon in the form of a union nut, and can be capable of being rotated via the housing operating area at least for the clamping of the insert tool. Simple geometries can be used that are available as standard parts or are easy to manufacture.

According to an advantageous embodiment, through a relative rotation of the operating area and the housing operating area one or more edges of the operating area can come into operative connection with the housing operating area. Thus, one or more protruding edges of the operating area can come into contact with the inner side of the housing operating area, thus producing an operative connection for transmitting a torque in order to clamp or release the insert tool. Alternatively, it is possible that the housing operating area has protruding edges and the operating area likewise has protruding edges that can be brought into contact in order to form an operative connection.

According to an advantageous embodiment, the tool mount can be fashioned as a chuck. A chuck has two or more clamping jaws situated about a receptacle into which the insert tool can be placed. During the clamping, the clamping jaws are pressed against the end of the insert tool placed into the receptacle, and hold it with a non-positive fit. This system is compact, and the insert tool can be clamped directly in the tool mount.

According to an advantageous embodiment, the tool mount can be integrated into an ultrasonic vibrating system. The tool clamping system permits the provision of high clamping forces required for an ultrasound-operated tool. The drive forces can be transmitted with high efficiency by the ultrasonic vibrating system to the integrated tool mount and thus to the insert tool placed therein.

According to an advantageous embodiment, the clamping element can have a threading having a conical run that cooperates with the tool mount. When the clamping element is tightened, by rotating the clamping element on a correspondingly conically running threading of the tool mount, an insert tool inserted into the tool mount can be clamped or released. For example, clamping jaws of the tool mount can be pressed together around the insert tool. Conversely, when the insert tool is released, the clamping element can be rotated in the opposite direction, and the pressure on the clamping jaws can be released.

According to an advantageous embodiment, the clamping element can have a threading having a cylindrical run, having a conical region outside the threading. When the clamping element is tightened, by rotating the clamping element on a correspondingly cylindrically running threading of the tool mount, an insert tool inserted in the tool mount can be clamped or released. For example, clamping jaws of the tool mount around the insert tool can have a suitable acting surface for the cone that presses the clamping jaws together when the clamping element is rotated. Conversely, when the insert tool is released, the clamping element can be rotated in the opposite direction and the pressure of the cone on the countersurface can be released so that the clamping jaws are released.

According to an advantageous embodiment, the clamping element can have a threading having a cylindrical run and can cooperate with a conically running chuck. The threading of the clamping element can be screwed onto a threaded piece connected fixedly to the housing, having a cone on its inner side, the conically running chuck with the insert tool placed therein being pressed into the cone of the threaded piece and thus clamping the insert tool.

According to a further aspect of the present invention, an electric machine tool is proposed having a tool clamping system that has at least one of the above-described features. In particular, the electric machine tool can be equipped with an ultrasonic vibrating system for driving an insert tool.

Advantageously, an electric machine tool can be created having a tool-free clamping system, in particular for ultrasonic applications.

Conventionally, the tightening or releasing of the clamping element, for example a union nut, is accomplished for example using a suitable open-end wrench. Instead of a separate additional clamping tool, a housing part having temporary direct contact with the clamping element is integrated into the housing design of the machine tool. Using this “in situ” clamping tool in the housing, the clamping element can then be released or tightened by the user without an additional tool.

The electric machine tool can be a cutter, a scraper, a drill, a miller, a saw, or the like. An embodiment as an ultrasonic tool for medical or dental use is also possible, for example as a so-called scaler for removing dental calculus, or as an ultrasonic scalpel.

The figures show exemplary embodiments of the present invention. The figures and the description below contain numerous features in combination. The features, however, may be regarded individually, and may be combined to form further combinations.

### BRIEF DESCRIPTION OF THE DRAWINGS

FIGS. 1a, 1b show a top view of a cross-section of an exemplary embodiment of a tool clamping system in the working position (FIG. 1a) and in the clamped position (FIG. 1b).

FIGS. 2a-2c show a longitudinal section of a detail of an exemplary embodiment of a tool clamping system having a conical threading (FIG. 2a), having a straight threading (FIG. 2b), and having a profiled receptacle for an insert tool (FIG. 2c).

FIG. 3 shows a longitudinal section of an exemplary embodiment of a tool clamping system having sufficiently flexible clamping jaws and inserted insert tool.

FIG. 4 shows a partly sectional view of an exemplary embodiment of a tool clamping system having a union nut and conically running chuck.

FIG. 5 shows a longitudinal section of an exemplary embodiment of a tool clamping system with a housing.

### DETAILED DESCRIPTION OF EXAMPLE EMBODIMENTS

In the Figures, components that are identical or are of the same type have been provided with identical reference characters.

In accordance with the present invention, a clamping element clamping system is provided, in particular a union nut clamping system, a housing part of the machine tool being realized such that the union nut can be clamped with this part. Here, a defined gap is provided between the union nut and the housing part, so that the ultrasonic vibration is not dampened as a result of friction. When the clamping element is however tightened (or loosened), then, given a correctly chosen dimension of the gap, after a short rotation a transmission of torque can take place between the clamping element and the housing part.

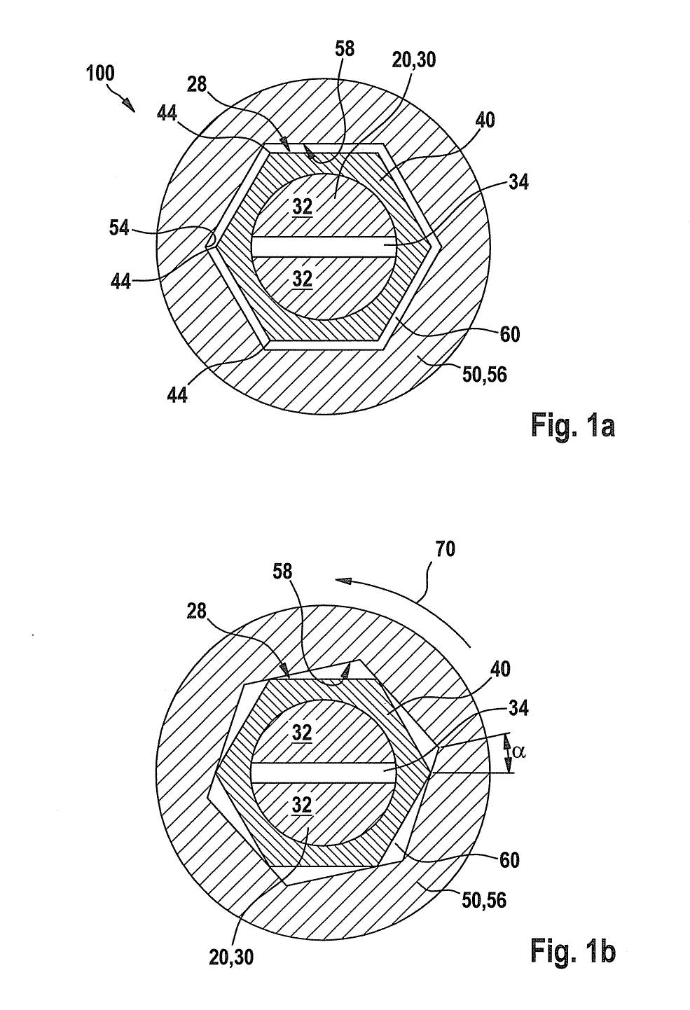

For the explanation of the present invention, FIGS. 1a and 1b show a top view of a cross-section of an exemplary embodiment of a tool clamping system 100 in the working position (FIG. 1a) and in the clamped position (FIG. 1b). Tool clamping system 100 for clamping an insert tool (not shown) in a machine tool is integrated into a housing 50, a tool mount 20 being provided as receptacle 34 for the insert tool.

Tool mount 20 has a clamping element 40 having an operating area 28 that works together with a housing operating area 58 of housing 50 at least for the clamping of insert tool 10. Housing operating area 58 is fashioned so as to be complementary in shape to operating area 28 of clamping element 40.

In the operating state, clamping element 40, or operating area 28 thereof, is separated by a gap 60 from housing operating area 58. The dimension of gap 60 can be selected as needed, and in particular can be between a few micrometers and some millimeters.

As can be seen in the figure, tool mount 20 can be fashioned as a chuck having clamping jaws 32 that surround a receptacle 34. Receptacle 34 may be, as shown, slot-shaped, or, depending on the area of use and the nature of the insert tool, may be round, e.g. for a drill, or may have angles.

In the depicted exemplary embodiment, receptacle 34 is slot-shaped in order for example to accept a blade, e.g., a cutting blade, a scraper blade, a grinding stone, or the like.

Clamping element 20 can for example be realized in the shape of a hexagonal union nut and a housing part 56 having housing operating area 58 as inner hexagon.

Housing part 56 is usefully mounted rotatably on the rest of housing 50, so that it is rotatable by a certain angular range a relative to tool mount 20. When housing part 56 is rotated in direction 70, for example in the counterclockwise direction when receptacle 34 is viewed from above as shown in FIG. 1b, housing part 56 can be freely rotated until its inner side, i.e., housing operating area 58, comes into contact with edges 44 of clamping element 40 fashioned as a union nut. Upon further rotation in direction 70, housing operating area 58 entrains clamping element 40, and thus transmits torque for clamping an insert tool inserted into the receptacle. For release, housing part 56 is correspondingly rotatable in the opposite direction.

Tool mount 20 can be part of a vibrating system, in particular an ultrasonic vibrating system 30. For example, receptacle 34 can be integrated into a sonotrode.

When a fastening torque is applied in order to clamp the insert tool, the two operating areas 28, 58 are rotated relative to one another until, after the small angle of rotation α, the component geometries engage with one another and the desired torque can be transmitted. If no torque is applied, then, due to a suitably selected gap dimension between the housing components (in particular housing operating area 58) and the vibrating components (in particular operating area 28), an amount of play is present that is sufficient to ensure that the ultrasonic vibration is not dampened by unnecessary frictional losses with the housing.

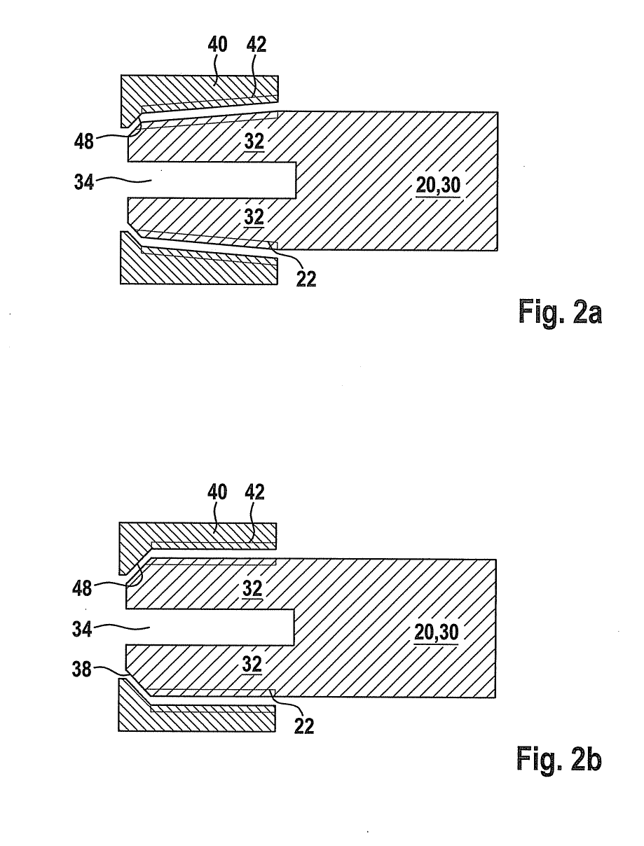

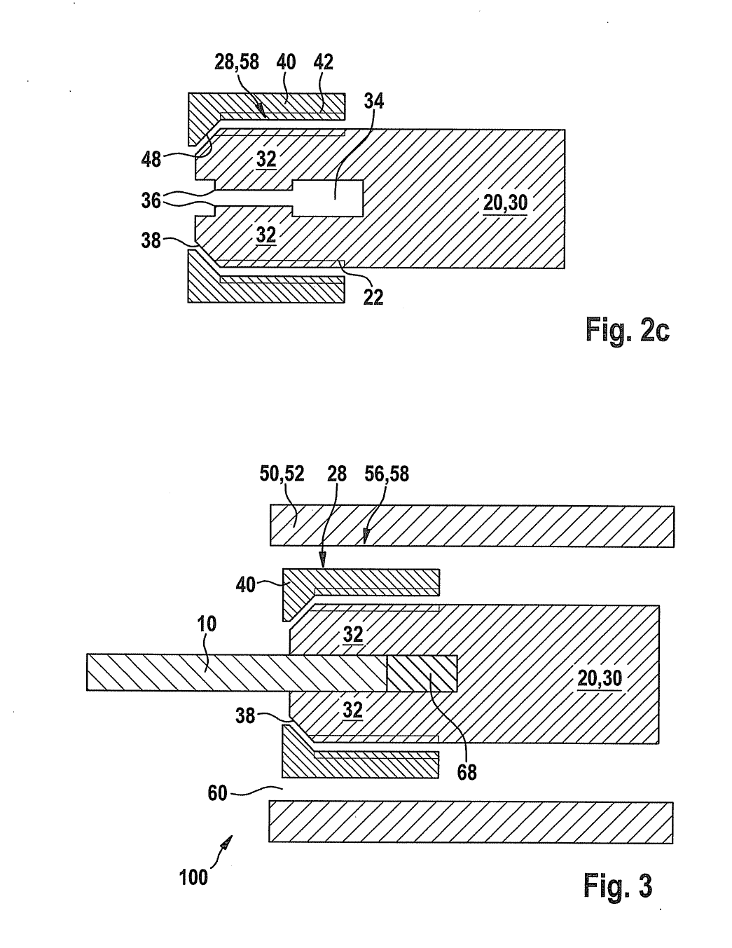

FIGS. 2a-2c show a longitudinal section of a detail of an exemplary embodiment of a tool clamping system 20 having a threading 42 having a conical run in clamping element 40 and a threading 22 having a conical run in clamping jaws 32 (FIG. 2a). FIG. 2b shows an embodiment having a threading 42 having a straight run in clamping element 40 and a threading 22 having a straight run in clamping jaws 32. FIG. 2c shows an embodiment having a profiled receptacle 34. In the representation, the housing operating area is not shown. For threading 32 on clamping jaws 32, if necessary a threaded insert (e.g. a so-called helicoil) can be selected that has a higher degree of hardness than the material of clamping jaws 32. This is advantageous in particular if clamping jaws 32 are a component of a sonotrode made of an aluminum material.

As an example, tool mount 20 is fashioned as a chuck having clamping jaws 32 around receptacle 34 for an insert tool (not shown). Threading 42 having a conical run in FIG. 2a has the result that when clamping element 40, fashioned as a union nut, is rotated, clamping jaws 32 are pressed together during the clamping by the conical run of threading 22, 42, and during release these jaws are released and can move apart from one another. An inserted insert tool is correspondingly clamped or released.

Optionally, as shown in FIG. 2a, it is possible to provide, in addition, a cone on the free end of clamping jaws 32 that works together with a corresponding inner cone of clamping element 40, fashioned as a union nut, and that supports the closing movement of clamping jaws 32.

Given straight-running threadings 22 and 42, as shown in FIG. 2b, inner cone 48 on the free end outside threading 42 of clamping element 40 presses clamping jaws 32 together during clamping by rotating clamping element 40, fashioned as a union nut. For this purpose, clamping jaws 32 have a corresponding conical surface 38 on their free end.

In a specific embodiment that is not shown, the insert tool can have a shoulder that, with the aid of the chuck, is pressed with a non-positive fit into receptacle 34 and thus for example against ultrasonic vibrating system 30. The shoulder can for example also be fashioned as a conical surface, and during the clamping can be pressed into receptacle 34 by clamping element 40, fashioned as a union nut.

FIG. 2c shows a variant of the embodiment shown in FIG. 2b in which the inner sides of clamping jaws 32 (“clamping chuck”) have a profile 36. This enables a punctiform or linear contact between the insert tool and clamping jaws 32. The surface inner sides of clamping jaws 32 can be profiled in such a way that a surface contact can take place only in the areas having sufficient clamping. The amount by which these parts are raised relative to the other, non-contacting areas here need only be a few micrometers. Alternatively, of course, the insert tool, e.g., a drill or a blade, can have raised parts or, e.g., beads at a suitable location in order to take on the above-described function. The clamping chuck can then remain unprofiled.

FIG. 3 shows a longitudinal section of a detail of an exemplary embodiment of a tool clamping system 100 having a blade as insert tool 10 in tool mount 20. In order to ensure that clamping jaws 32 of tool mount 20 are sufficiently flexible, receptacle 34 is made significantly deeper than the actual insertion depth of insert tool 10. As shown in the Figure, an elastic material 68, such as rubber, is situated in the rear part of the receptacle. Elastic material 68 can for example be attached by, e.g., gluing or clamping. Elastic material 68 does not influence the bending of clamping jaws 32 in a disturbing manner, and acts as a depth stop for insert tool 10 that is to be inserted.

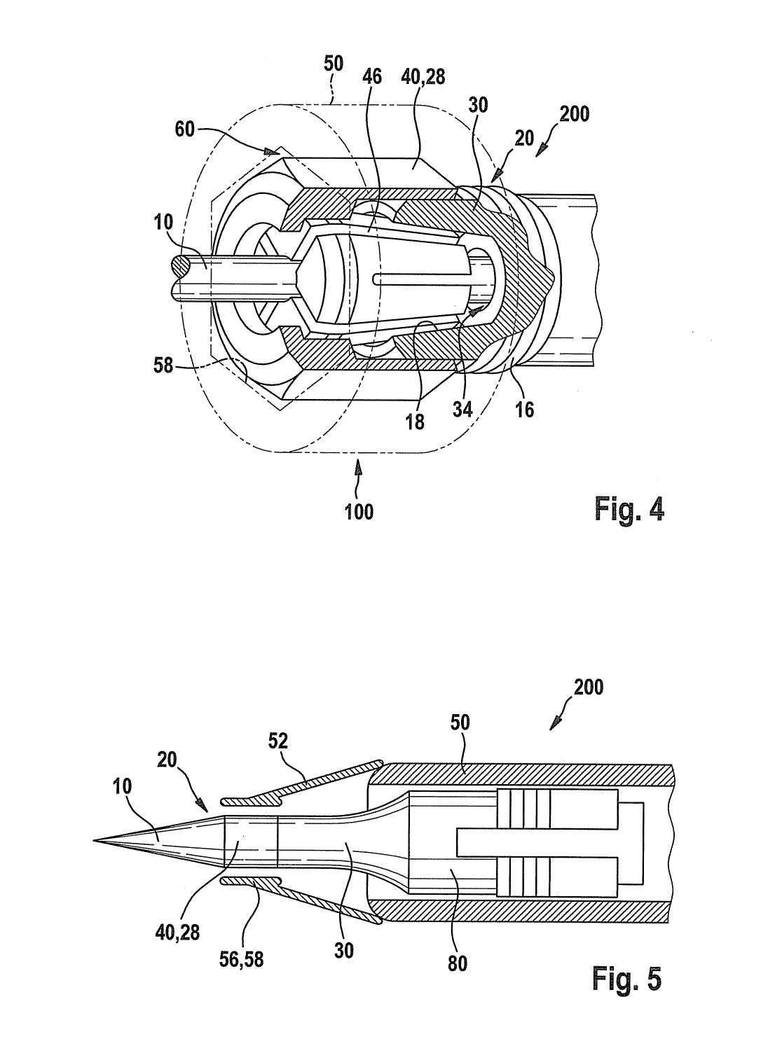

FIG. 4 shows a partly sectional view of an exemplary embodiment of a tool clamping system 100 of a machine tool 200 having a clamping element 40 fashioned as a union nut and having a conically running chuck 46. Tool mount 20 has an outer threading 16 onto which clamping element 40, fashioned as a union nut, can be screwed for the clamping when its operating area 28 works together with housing operating area 58. Clamping element 40, fashioned as a union nut, has at its free end a guide edge on which the end face of chuck 46 lies. During the clamping, clamping element 40, fashioned as a union nut, moves chuck 46 toward receptacle 34. Tool mount 20, bearing threading 16, is provided with an inner cone 18 into which chuck 46 is driven during the clamping, so that chuck 46 non-positively clamps a shaft of insert tool 10 extending into receptacle 34. Tool mount 20 can in particular be integrated into an ultrasonic system 30. In this way, a sonotrode can be fashioned as tool mount 20, and can have threading 16, inner cone 18 and receptacle 34.

FIG. 5 shows a longitudinal section of an exemplary embodiment of a tool clamping system 100 of a machine tool 200 having a housing 50. Machine tool 200 is for example an ultrasound-operated machine tool 200 having an ultrasonic drive system 80 in whose vibration system 30, for example a sonotrode, a tool mount 20 is integrated. Housing 50 extends past tool mount 20 with a housing part 52 having an end 56. An insert tool 10 is releasably fastened in tool mount 20. A clamping element 40, fashioned for example as a union nut, has on its outer side an operating area 28 that works together with an operating area 58 of housing part 56, in particular its inner side, in order to clamp and to release insert tool 10 in the manner described above.

Here, housing part 56 or housing part 52 can be connected rotatably to the rest of housing 50.

Optionally, housing part 52 or 56 can have an integrated (e.g. spring-actuated) torque measuring device that emits a signal to the user when the provided torque is achieved. This signal can be emitted for example as a clicking, similar to that emitted by a drill chuck, or in the form of some other acoustic and/or optical signal. Alternatively, the reaching of the target torque can be indicated, as in the case of torque wrenches, by a short-term resilience in the torque curve, so that the user can detect this when the corresponding housing part 52, 56 is rotated.

What is claimed is:

1. A tool clamping system for clamping an insert tool in a machine tool, comprising:
a housing; and
a tool mount configured to receive and clamp the insert tool, the tool mount including a clamping element having an operating area that works together with a housing operating area of the housing at least for the clamping of the insert tool, wherein the operating area of the clamping element is separated by a gap from the housing operating area when the insert tool is in an operating state.

2. The tool clamping system as recited in claim 1, wherein the machine tool is an ultrasonic-operated machine tool.

3. The tool clamping system as recited in claim 1, wherein the housing operating area has a shape complementary to that of the operating area of the clamping element.

4. The tool clamping system as recited in claim 1, wherein the clamping element is in the shape of a polygon in a form of a union nut, and is capable of being rotated via the housing operating area at least for clamping of the insert tool.

5. The tool clamping system as recited in claim 1, wherein the tool mount and the housing are configured so that through a relative rotation of the operating area of the clamping element and the housing operating area, at least one edge of the operating area of the clamping element comes into operative connection with the housing operating area.

6. The tool clamping system as recited in claim 1, wherein the tool mount is a chuck.

7. The tool clamping system as recited in claim 1, wherein the tool mount is integrated into an ultrasonic vibrating system.

8. The tool clamping system as recited in claim 1, wherein the clamping element has a threading having a conical run.

9. The tool clamping system as recited in claim 1, wherein the clamping element has a threading having a cylindrical run and has a conical area outside the threading.

10. The tool clamping system as recited in claim 1, wherein the clamping element has a threading having a cylindrical run, and works together with a conically running chuck.

11. An electric machine tool having a tool clamping system, the tool clamping system including a housing, and a tool mount configured to receive and clamp an insert tool, the tool mount including a clamping element having an operating area that works together with a housing operating area of the housing at least for the clamping of the insert tool, wherein the operating area of the clamping element is separated by a gap from the housing operating area when the insert tool is in an operating state.

12. The electric machine tool as recited in claim 11, further comprising:
an ultrasonic vibrating system for driving the insert tool.
